(19) United States
(12) Patent Application Publication
(10) Pub. No.: US 2007/0006795 A1
(43) Pub. Date: Jan. 11, 2007

(54) Window rescue locator and method

(75) Inventors: Jay Z. Muchin, Manitowoc, WI (US); David J. Merten, Manitowoc, WI (US)

Correspondence Address: RATHE PATENT & IP LAW, 10611 W. HAWTHORNE FARMS LANE, MEQUON, WI, 53097, US

(73) Assignee: M Group, Inc., Manitowoc, WI (US)

(21) Appl. No.: 11/455,115

(22) Filed: Jun. 16, 2006

Related U.S. Application Data
(60) Provisional application No. 60/697,220, filed on Jul. 7, 2005.

(51) Int. Cl. G01N 31/22

(52) U.S. Cl. 116/200

(57) ABSTRACT

A rescue locator and related methods are disclosed.

### CROSS-REFERENCE TO RELATED PATENT APPLICATIONS

The present application is related to and claims priority under 35 USC section 119 from co-pending U.S. provisional patent application Ser. No. 60/697,220 filed on Jul. 7, 2005 by Jay Z. Muchin et al. and entitled WINDOW RESCUE STICKER AND METHOD, the full disclosure which is hereby incorporated by reference.

### BACKGROUND

Fires and other residential emergencies claim many lives every year. In many cases, fire fighters or other emergency rescue crews are left to making educated guesses as to the layout of a residence to determine rescue strategies.

### BRIEF DESCRIPTION OF THE DRAWINGS

FIG. 1 is a front elevational view of a rescue locator applied to a residence and being used during a rescue operation according to an example embodiment.

FIG. 2 is a front view of one example embodiment of the rescue locator of FIG. 1 according to an example embodiment.

### DETAILED DESCRIPTION OF THE EXAMPLE EMBODIMENTS

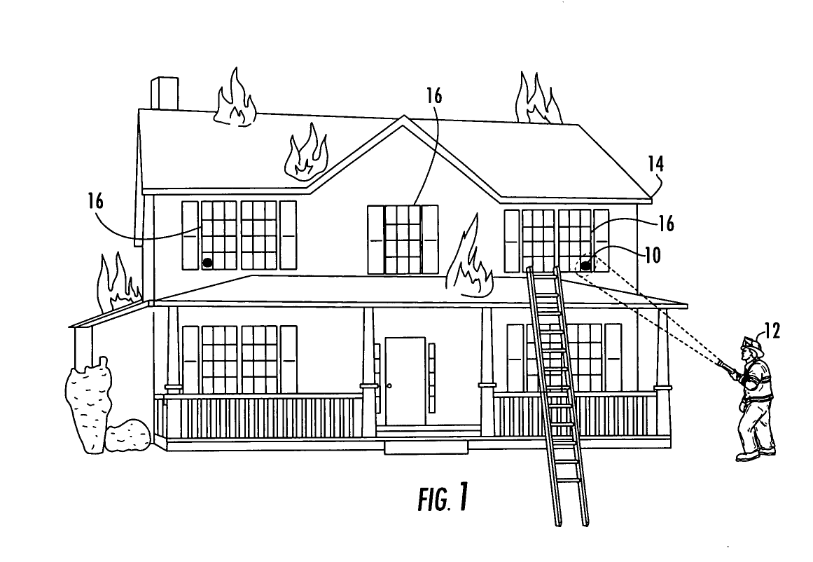

FIG. 1 illustrates an emergency rescue locator 10 and its use during rescue operations according to one example embodiment. In particular, FIG. 1 illustrates the use of emergency rescue locator 10 to assist rescue workers 12, such as fire fighters, in developing strategies for rescuing occupants of a residence 14. Emergency rescue locator 10 comprises an indicia configured to be provided on or adjacent to occupied bedroom windows of residence 14 and further configured to communicate information to rescue workers 12 outside of the residence 14 to assist in rescue operations. Rescue locator 10 assists in rescue operations by communicating to rescue workers 12 outside of residence 14 information identifying those windows associated with occupied bedrooms. As a result, rescue workers 12 may immediately identify those rooms of residence 14 that should be more closely searched for survivors or initially accessed. Locators 10 enable rescue workers 12 to focus their searches in critical areas of residence 14. During such searches, time is of the utmost importance. Rescue locators 10 save rescue workers valuable time.

In addition to communicating information identifying those windows associated with occupied bedrooms, rescue locators 10 are configured to identify such occupancy without communicating the general age of the occupant. In other words, rescue locators 10 do not identify the occupant as being a child. As a result, rescue locators 10 do not communicate to strangers information identifying bedrooms of a residence 14 which are occupied by those most vulnerable. As a result, rescue locators 10 may assist in preventing unauthorized intrusions such as robberies, kidnappings and the like.

According to one example embodiment, rescue locators 10 include words or graphics identifying the locator as a rescue locator such that the rescue worker can distinguish locators 10 from other indicia, stickers or markings. In one embodiment, rescue locators 10 include words or graphics indicating the presence of an adult person. In particular embodiments, such rescue locators may additionally include words or graphics indicating the additional presence of a child. Because rescue locators 10 indicate the presence of both an adult and a child, rescue locators 10 do not specifically identify the bedroom as being occupied by a child. In particular embodiments, rescue locators 10 may further include words or graphics indicating in particular type of emergency for which the indicia is intended. For example, in some embodiments, rescue locator 10 specifically identifies itself as an occupant locator in the case of fires. Any of the aforementioned information may be communicated by specific words, graphics placed for formed on locator 10 or a shape of locator 10.

According to one example embodiment, rescue locators 10 are configured to be removably adhered to a bedroom window. As a result, rescue locators 10 may be removed as the particular occupancy characteristics of residence 14 change. In addition, locators 10 may be more easily added to windows of residence 14. In one embodiment, rescue locators 10 may comprise decals including adhesive such that locators 10 comprise stickers. In other embodiments, rescue locators 10 may comprise decals from a material such that locators 10 be applied or adhere to the glass pane of the window by electrostatic, suction, magnet, VELVRO or other forces. In those embodiments in which rescue locators 10 are configured for identifying occupied bedrooms of a home during a fire, rescue locators 10 include adhesives or other adhering materials configured to remain adhered to the glass pane of a window or other structure associate with the window and viewable from outside residence 14 during the high temperatures which occur during a fire.

In one embodiment, rescue locators 10 are configured to be adhered to the surface of the glass pane a window on an exterior of residence 14. In such embodiments, rescue locators 10 have a front outer side including indicia or graphics for communicating occupancy information and a back side configured to adhesively or electrostatically adhere to the glass pane. In such embodiments, rescue locators 10 are formed from a weather resistant material to resist unintended separation from the window and to prevent or slow the fading of the words or other graphics communicating occupancy information.

In other embodiments, rescue locators 10 are configured to be adhered to the glass pane of the window on an interior of the residence. In such an embodiment, the same side or surface of rescue locator can includes both graphics or words communicating occupancy information and adhesives, surface materials and the like for adhering to the glass pane of the window. In such an embodiment, the words or graphics may be printed otherwise formed upon the surface prior to coating of the surface with an adhesive (releasable or permanent) or electrostatic cling material.

In particular embodiments, rescue locators 10 are specifically configured to be more easily viewed and identified by rescue workers 12 during an emergency. In one embodiment, rescue locators 10 have a highly reflective surface facing an outside of residence 14 when locators 10 are positioned with respect to a window. In another embodiment, rescue locators 10 have a luminescent surface facing an outside of residence 14 when locators 10 our position with respect to a window. For example, the outer surface of rescue locators 10 may be provided with a “glow-in-dark” type material which stores light energy during daylight hours and which emits light during periods of darkness. In one embodiment, rescue locators 10 may be provided with both reflective and luminescent characteristics. The reflective and the luminescent characteristics of rescue locators 10 facilitate quicker identification of rescue locators 10 by rescue workers 12 during hours of darkness.

To further facilitate their identification, rescue locators 10 have a size facilitating their viewing. For example, in one embodiment, rescue locators 10 have a diameter of at least 2 inches. In one embodiment, rescue locators 10 have a diameter of about 2.5 inches. In addition, rescue locators can have a complex shape or our periphery (i.e. non-round, non rectangular etc) different from other shapes that may otherwise be associate it with a window.

FIG. 1 illustrates general use of rescue locators 10. Prior to an emergency, an occupant of residence 14 or other person places rescue locators 10 in or adjacent to those windows 16 of residence 14 associated with occupied bedrooms. Such rescue locators 10 are placed in windows 16 of bedrooms occupied by adults and in windows 16 of bedrooms occupied by children. Rescue locators 10 are not placed on windows which are associated with rooms other than occupied bedrooms. As noted above, in particular embodiments, rescue locators 10 may be adhered to the inner surface of a window pane. In other embodiments, rescue locators 10 may be adhered to the exterior of a window pane.

During an emergency, a rescue worker 12 checks windows 16 to identify those windows 16 having rescue locators 10. In general, rescue workers 12 or first responders on the scene may perform a “360° walk around” of residence 14 attempting to find people, to find the source of the fire or other emergency and to determine a layout of bedrooms in the residence. Upon identifying those windows having rescue locators 10, rescue workers 12 may also identify occupied bedrooms of residence 14 and better develop a mental map of the premises. In particular scenarios, rescue workers 12 may access those windows or associated bedrooms first time before accessing other rooms, to search for survivors. Because rescue locators 10 all are adhered to windows 16 to identify those bedrooms occupied by adults, rescue workers 12 may reach such adult survivors more quickly. Reaching such adult survivors sooner enables rescue workers 12 to gather valuable information from such adult survivors regarding the number and location of other survivors remaining in residence 14, the potential source of the emergency or fire and more details regarding the layout of residence 14. Reaching only children first may result in less information or less accurate information.

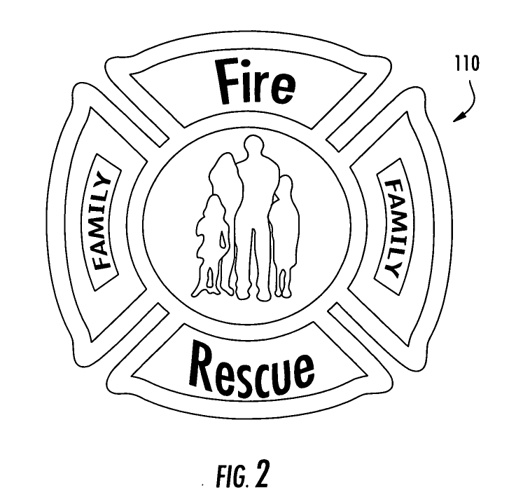

FIG. 2 illustrates rescue locator 110, one example of rescue locator 10. Rescue locator 110 communicates information identifying the associated bedroom as being occupied by either adults or children (not specifically and only children). Rescue locator 110 communicate is information graphically by depicting both adults and children and with words such as the words “family”. Rescue locator 110 further identifies itself as a rescue locator graphically by its shape and with words such as “rescue”. Rescue locator 110 further communicates the type of emergency for which locator 110 may be used through the use of graphics or its shape and with words such as “fire”. Rescue locator 110 has a complex shape or graphical outer perimeter (a rescue symbol or cross) to further distinguishes from other general shapes such as circles and squares. In the particular example illustrated, rescue locator 110 has a diameter of about 2.5 inches, is highly reflective so as to be visible both the day and night, is luminescent so as to glow or emit light during darkened hours and is formed from a weather resistant material. In one embodiment, rescue locator 110 includes adhesives on the illustrated face, enabling rescue locator 110 to be adhered in an inside surface of a window pane. In other embodiments, the back side of rescue locator 110 may be provided with an adhesive material. In yet other embodiments, such adhesive materials may be replaced with materials facilitating adherence of rescue locator 110 to a glass pane via electrostatic forces. In other embodiments, rescue locator 110 may have other sizes, shapes, dimensions, graphics and words performing similar functions.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
applying an indicia to a bedroom window of a residence that is visible from outside the residence to distinguish the bedroom window from other windows of the residents without identifying the bedroom window as that of a child's bedroom.

2. The method of claim 1, wherein the indicia is configured to be removably adhered to the bedroom window

3. The method of claim 1, wherein the indicia a comprises a sticker

4. The method of claim 1, wherein the indicia comprises a decal.

5. The method of claim 1, wherein the indicia is reflective.

6. The method of claim 1, wherein the indicia is luminescent.

7. The method of claim one, wherein indicia includes words or graphics indicating presence of an adult person.

8. The method of claim 1, wherein the indicia includes words or graphics identifying the indicia as a fire rescue locator.

9. The method of claim 1 further comprising accessing bedrooms having the indicia before accessing other rooms of the residents during a fire rescue operations.

10. The method of claim nine further comprising questioning an occupant of the bedroom having the indicia upon accessing the bedroom.

11. A method comprising:
adhering a first reflected or luminescent fire rescue locator on our proximate a bedroom of an adult person of a residence.

12. The method of claim 10 further comprising adhering a second reflective or luminescent fire rescue locator on or proximate a bedroom of a child of the residence.

13. The method of claim 10, wherein the indicia includes words or graphics indicating presence of an adult person.

14. The method of claim 13, wherein the indicia includes words or graphics identifying the indicia as a fire rescue locator.

15. A rescue locator comprising:
a decal configured to be adhered to a window of a residence;
words or graphics on the decal identifying the decal as a fire rescue locator; and
words or graphics on the decal or a shape of the decal indicating the presence of an adult person in the bedroom of the window in which the decal is configured to be adhered.

16. The locator of claim 15, were in the decal has a shape identifying it as a fire rescue locator.

17. The locator of claim 15, were in the decal includes the word “fire”.

18. The locator of claim 15, wherein the decal includes a graphic depicting both an adult and a child.

19. The locator of claim 15, were in the decal has a dimension of at least 2 inches.

20. The locator of claim 15, wherein the decal is luminescent.
